(19) United States
(12) Patent Application Publication
(10) Pub. No.: US 2015/0292459 A1
(43) Pub. Date: Oct. 15, 2015

(54) FUEL PUMP ASSEMBLY

(71) Applicant: DELPHI INTERNATIONAL OPERATIONS LUXEMBOURG, S.A.R.L., BASCHARAGE (LU)

(72) Inventor: Anthony John Williams, Isleworth (GB)

(21) Appl. No.: 14/394,125

(22) PCT Filed: Apr. 10, 2013
(86) PCT No.: PCT/EP2013/057480

§ 371 Date: Oct. 13, 2014

(30) Foreign Application Priority Data
Apr. 25, 2012 (GB) 1207235.1

(51) Int. Cl. F02M 59/02; F02B 9/02; F02M 59/10

(52) U.S. Cl. CPC F02M 59/027; F02M 59/102; F02B 9/02

(57) ABSTRACT

A fuel pump assembly for an internal combustion engine comprising at least one engine cylinder into which fuel is injected, each cylinder having an associated cylinder piston which reciprocates within the associated cylinder in use. The fuel pump assembly comprises a plurality of unit pumps each having a pumping plunger for pressurising fuel within an associated pump chamber; and a crank shaft which is driven rotationally by means of the or each cylinder piston. The crank shaft carries a cam arranged to drive the pumping plungers of the unit pumps and further carries at least one crank assembly which is coupled to a respective one of the cylinder pistons, in use. The plurality of unit pumps are radially spaced around the crank shaft and located at the same axial position along the crank shaft so that each of the unit pumps is driven, in use, by the same cam.

### CROSS REFERENCE TO RELATED APPLICATIONS

This application is a national stage application under 35 U.S.C. 371 of PCT Application No. PCT/EP2013/057480 having an international filing date of 13 Apr. 2013, which designated the United States, which PCT application claimed the benefit of Great Britain Patent Application No. 1207235.1 filed on 25 Apr. 2012, the entire disclosure of each of which are hereby incorporated herein by reference.

### TECHNICAL FIELD

The invention relates to a fuel pump assembly of the type suitable for use in a fuel injection system of an internal combustion engine and in particular for use in a compression ignition internal combustion engine.

### BACKGROUND TO THE INVENTION

In known pump assemblies for use in internal combustion engines, a plurality of unit pumps are provided to supply pressurised fuel to the fuel injectors of the engine. In some unit pump or unit pump/injector type arrangements, fuel that is pressurised within each unit pump is delivered to only its dedicated injector. In other common rail-type systems, each unit pump is arranged to supply pressurised fuel to a common rail, from where fuel is delivered to all of the injectors of the engine. Typically, the components of the unit pumps are arranged within modular pump housings which are mounted on the engine block either internally or externally.

Each unit pump includes a plunger that is driven for reciprocal movement within a bore provided in the pump housing by means of a cam drive arrangement. Typically, the cam drive arrangement is mounted on a cam shaft and includes a cam and a cam follower (such as a roller) which cooperates with the cam so as to drive a pumping stroke of the plunger during which fuel is pressurised as the cam shaft is driven and the cam rotates.

The cam shaft is driven by the crank shaft via a gear train, typically at half the speed of crank shaft rotation. The engine crank shaft is housed within a crank case which typically forms an integral part of the engine block. The engine block, often referred to as the cylinder block, is an integrated structure which includes the cylinders of the engine within which compression and expansion of fuel, air and combustion gasses takes places to power the engine. The cam shaft is also used to drive operation of the intake and exhaust valves for the engine cylinders.

The crank shaft is the part of the engine which translates reciprocating linear motion of the cylinder pistons into rotation. The crank shaft carries a plurality of crank pins, one for each engine cylinder, and to which an end of a connecting rod from each engine cylinder is attached. In some V-engines, there are two connecting rods coupled to a single crank pin. As the pistons are driven through the combustion cycle, the crank pins are caused to rotate so as to rotate the crank shaft.

It is commonplace to mount the unit pumps such that they are driven from the cam shaft of the engine. It has also been suggested previously to mount the unit pumps such that they are driven directly from the crank shaft. An example of an arrangement in which a unit pump is mounted on a crank shaft is described in JP 2008-014159. This provides the benefit that the unit pumps are not driven via gear train components and so gear train noise and stress are eliminated. In JP 2008-014159, the unit pump is mounted at the far end from the power output end of the shaft and so may balance the weight of the gearbox.

It is an object of the invention to provide a further improvement to the pump assembly of the aforementioned type in which the or each unit pump is mounted directly on the crank shaft, rather than on the cam shaft as in a more conventional arrangement.

### STATEMENTS OF INVENTION

According to a first aspect of the invention, there is provided a fuel pump assembly for an internal combustion engine comprising at least one engine cylinder into which fuel is injected, each cylinder having an associated cylinder piston which reciprocates within the associated cylinder. The fuel pump assembly comprises a plurality of unit pumps, each unit pump having a pumping plunger for pressurising fuel within an associated pump chamber, which may form part of the unit pump, for delivery to an associated fuel injector of the engine. A crank shaft is driven rotationally by means of the or each cylinder piston, the crank shaft comprising a power output end, at which an engine gearbox may be mounted, and an end remote from the power output end. The crank shaft carries a cam which is arranged to drive the pumping plungers of the unit pumps, and also carries at least one crank assembly. The or each crank assembly is coupled to a respective one of the cylinder pistons, in use.

The fuel injector may form an integral part of the unit pump, or may be a separate component.

Typically, the engine gearbox is located at and driven by the power output end of the crank shaft.

In one embodiment, the cam may be mounted at the end of the crank shaft remote from the power output end. This places the cam, and hence the unit pumps, at an accessible part of the engine (i.e. typically the front of the engine).

In another embodiment, the cam may be mounted on the crank shaft so that there is at least one crank assembly located between the cam and the remote end of the crank shaft. This places the unit pumps in a relatively inaccessible location within the engine, but has the benefit of the unit pumps being located in a tamper-proof location.

The fuel pump assembly may further comprise a housing for the crank shaft. The housing may take the form of an engine housing, or engine block. The unit pumps may be mounted at least partially within the engine block, and more preferably fully within the engine block. In one particular embodiment, a crank case or crank housing for the crank shaft forms an integral part of the engine housing, and the unit pumps are mounted fully within the crank case.

In another embodiment, the fuel pump assembly further comprises mounting means for mounting the unit pumps externally to the engine housing.

The unit pumps may be mounted within a common pump housing which is mounted externally to the engine housing by means of the mounting means.

Alternatively, each of the unit pumps may be mounted within its own dedicated housing which is mounted to the engine housing by means of an associated mounting means.

Preferably, the crank assembly includes a crank pin and a connecting rod which couples to the cylinder piston.

The fuel pump assembly of the invention provides the benefit that the existing engine component, in the form of the crank shaft, can be used to drive the pumping plungers, rather than utilising a separate cam shaft. This means that there are no gear train components between the drive shaft and the pumping plunger and so gear train noise and stress is eliminated.

Each of the unit pumps may further comprise a roller which cooperates with the cam and a shoe which at least partially encloses the roller and which is driven by the roller as it rides over the cam, in use, whereby the shoe cooperates with the associated pumping plunger so as to impart drive thereto as the cam rotates with the crank shaft.

In another example each of the unit pumps further comprises a roller which cooperates with the cam and a follower such as a tappet which is driven by the roller as the roller rides over the cam, in use, whereby the follower cooperates with the associated pumping plunger so as to impart drive thereto as the cam rotates with the crank shaft. In one example, the follower is a tappet.

A fly wheel may be mounted at the power output end of the crank shaft. The flywheel serves to steady rotation of the crank shaft.

The cam may, for example, form an integral part of the crank shaft or may be a separate component carried by the crank shaft.

According to a second aspect of the invention, a fuel pump assembly for an internal combustion engine comprising at least one engine cylinder into which fuel is injected, each cylinder having an associated cylinder piston which reciprocates within the associated cylinder in use. The fuel pump assembly comprises a unit pump having a pumping plunger for pressurising fuel within a pump chamber for delivery to one of more fuel injectors of the engine. A crank shaft is driven rotationally by means of the or each cylinder piston, the crank shaft comprising a power output end, at which an engine gearbox is mounted, and an end remote from the power output end. The crank shaft carries a cam which is arranged to drive the pumping plunger of the unit pump and carrying at least one crank assembly, the or each crank assembly being coupled to a respective one of the cylinder pistons, in use. The cam is mounted on the crank shaft so that there is at least one crank assembly located between the cam and the remote end of the crank shaft.

According to a third aspect of the invention, there is provided a compression ignition internal combustion engine comprising a plurality of engine cylinders each having a reciprocal cylinder piston and a pump assembly in accordance with the first aspect of the invention, wherein the cylinder pistons drive rotation of the crank shaft, in use. Typically in such an engine the pressure of fuel that is injected into the engine cylinders for combustion is at a pressure of at least 1000 bar, and more typically at least 2000 bar.

Preferred and/or optional features of the first or second aspects of the invention may be incorporated alone or in appropriate combination in the third aspect of the invention also.

### BRIEF DESCRIPTION OF THE DRAWINGS

The invention will now be described, by way of example only, with reference to the following figures in which:

FIG. 1 is a perspective view of a fuel pump assembly which illustrates a feature of a first embodiment of the invention, that a unit pump is mounted directly on an engine crank shaft;

FIG. 2 is a cross-sectional view of a unit pump forming part of the fuel pump assembly in FIG. 1;

FIG. 3 is a perspective view of another arrangement in which the unit pump is mounted directly on the engine crank shaft, but in a different location to that shown in FIG. 1;

FIG. 4 is an end view of an embodiment of the invention in which the cam is mounted directly on the crank shaft, and at an end of the crank shaft remote from the location shown in FIG. 1; and

FIG. 5 is perspective view of the embodiment in FIG. 4, in which two unit pumps are mounted on the same multi-lobe cam which is mounted directly on the crank shaft.

### DETAILED DESCRIPTION OF PREFERRED EMBODIMENTS

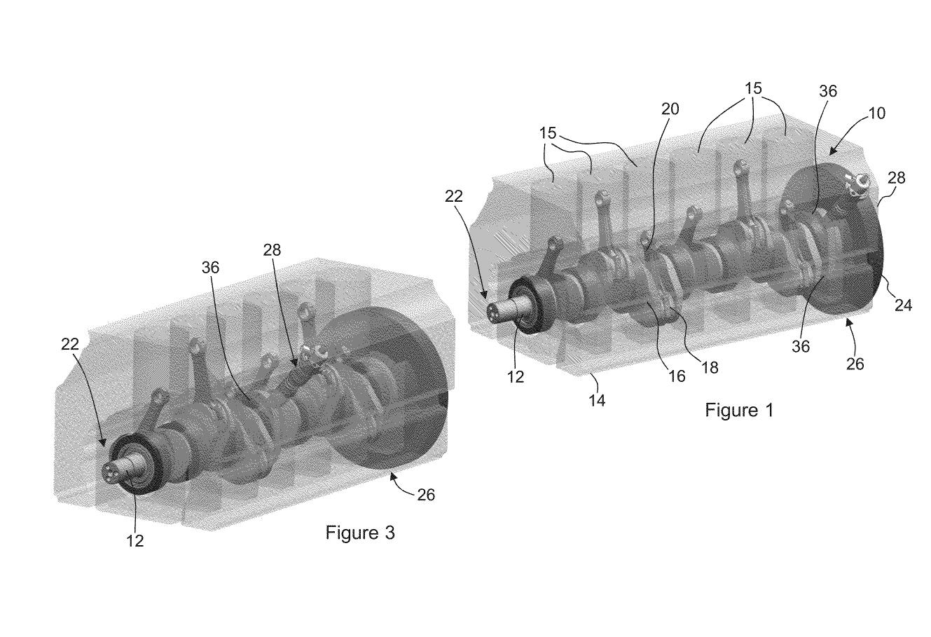

Referring to FIG. 1, a six cylinder compression ignition internal combustion engine includes a fuel pump assembly, referred to generally as 10, including an engine crank shaft 12 housed within a crank case which forms an integral part of the engine housing, referred to as the “engine block” 14. The engine cylinders 15 into which fuel is injected are defined within the engine block 14. Each cylinder 15 has an associated cylinder piston (not shown) which reciprocates within the cylinder. In the embodiment shown in FIG. 1 the crank shaft 12 carries seven bearings 16 (only one of which is indicated by reference number 16), one bearing 16 being mounted between each engine cylinder 15 and one being mounted at each end of the crank shaft 12. Adjacent ones of the bearings 16 are spaced apart by an associated crank assembly. Each crank assembly includes a connecting rod 20 and a crank member in the form of a pin 18 which defines the journal of the bearing at the end of the connecting rod 20. The other end of the connecting rod 20 is attached to the associated one of the cylinder pistons. The axis of the crank pin 18 is offset from that of the crank shaft 12 so that the crank pins 18 convert the linear reciprocating motion of the cylinder pistons into rotational motion of the crank shaft 12. As the cylinder pistons are driven through the combustion cycle the crank pins 18 are caused to rotate about the crank shaft 12.

The crank shaft 12 includes a power output end 26 which is coupled to an engine gearbox (not shown) and a second end 22 which is remote from the power output end 26, and hereafter referred to as the remote end 22 of the crank shaft. A flywheel 24 is mounted at the power output end 26 to steady the crank shaft and to maintain a constant angular velocity of the crank shaft 12 as it is driven, in use. At the same end of the crank shaft as the flywheel 24 (i.e. at the power output end 26), a unit pump 28 is mounted on the crank shaft 12. The unit pump 28 is mounted or carried by the crank shaft 12 inward of the flywheel 24 but outward of the crank assembly which is located farthest from the remote end 22 of the shaft 12. In other words, the unit pump 28 is located between the end one of the crank assemblies 18, 20 and the flywheel 24. Because the unit pump 26 is mounted directly on the crank shaft 12, there is no need for any intermediate gearing between a drive shaft and the cam 36, as is common in more conventional arrangements.

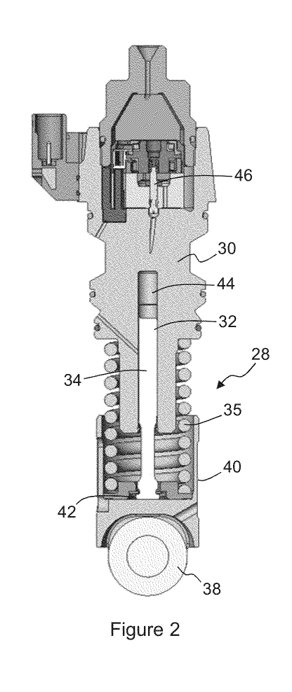

As shown in further detail in FIG. 2, the unit pump 28 includes a pump housing 30 within which a plunger bore 32 is provided to house a reciprocating pumping plunger 34 which performs a pumping cycle including a return stroke and a pumping stroke. The crank shaft 12 carries a cam 36 which has three cam lobes. Other cam forms are envisaged, as will be described in further detail below.

The unit pump 28 further includes a roller 38 which is engaged with the cam 36 and rides over the cam surface, in use, as the crank shaft 12 rotates. An intermediate drive member in the form of a bucket tappet 40 is coupled to the roller 38 via a pin and axle so that, as the roller 38 rides over the surface of the cam 36, the tappet 40 is caused to reciprocate linearly. The tappet 40 is coupled to the plunger 34 via a spring clip 42 so that, as the tappet 40 reciprocates, so too does the plunger 34. The pumping stroke of the plunger 34 is driven by means of the cam 36 as it drives the tappet 40, and the return stroke of the plunger 34 is driven by means of a plunger return spring 35.

In other embodiments (not shown), a roller-shoe arrangement may be used as the intermediate drive arrangement between the cam and the plunger. In this case the shoe may partially enclose the roller which, as it rides over the cam surface, serves to drive the shoe and, hence, the pumping plunger through the pumping cycle.

The plunger bore 32 defines a pump chamber 44 at its end remote from the tappet 40. The unit pump 28 is provided with a metering valve 46 which controls fuel flow into and out of the pump chamber 44 at the appropriate points in the pumping cycle. A further outlet valve (not shown) controls only the flow of pressurised fuel from the pump chamber 44.

The pump chamber 44 receives fuel at transfer pressure from a supply passage (not shown) via the metering valve 46. The metering valve 46 is a spring-biased valve which is spring-biassed open by means of a biasing spring and which is operated to close, against the biasing spring, by means of an electromagnetic actuator. The outlet valve is a spring-biased outlet valve which opens against the biasing spring once fuel within the pump chamber 44 reaches a predetermined level. With both valves closed and with the plunger 34 moving inwardly within the plunger bore 32 to reduce the volume of the pump chamber 44, fuel within the pump chamber 44 is pressurised. As fuel is pressurised within the pump chamber 44 a point will be reached at which the outlet valve is caused to open, allowing pressurised fuel to flow to a downstream common rail (not shown). As the cam 36 includes three cam lobes, a single rotation of the crank shaft 12 results in the plunger 34 performing three pumping cycles. For each pumping cycle, the outlet valve is opened to deliver a quantity of pressurised fuel to the common rail.

In an alternative arrangement, as shown in FIG. 3, the unit pump 28 is not arranged adjacent to the flywheel 24 at the power output end 26 of the crank shaft 12 but is instead mounted part-way along the length of the crank shaft 12. The unit pump 28 is mounted approximately centrally on the crank shaft 12 so that three of the crank assemblies separate the unit pump 28 from the power output end 26 of the crank shaft 12 and three of the crank assemblies separate the unit pump 28 from the remote end 22 of the crank shaft 12. Again, as in the previous embodiment, the unit pump 28 is mounted on the crank shaft 12 at a position spaced from the remote end 22 of the crank shaft 12. The unit pump 28 is again housed entirely within the engine block 14. The unit pump 28 therefore occupies a position in which accidental tampering can be avoided.

There are two options for mounting the unit pump to the engine block 14. The pump housing may be mounted within a pocket (not identified) within the crank case so that it locates entirely within the engine block 14. A benefit of this is that assembly of the engine is easier, and the overall parts count is low. The inaccessibility of the unit pump 28 within the crank case for service purposes need not be a disadvantage, and instead may provide the benefit that accidental tampering with the unit pump 28 is avoided.

In another arrangement the pump housing 30 may be provided with mounting lugs or brackets (not shown) which may be secured to the engine block 14 by means of bolts. In this case the unit pump is located externally to the crank case 14 so that accessibility is easier. A benefit of this arrangement is that all fuel connections to the unit pump may be via fuel hoses, rather than there being a requirement to form fuel passages within the engine block itself.

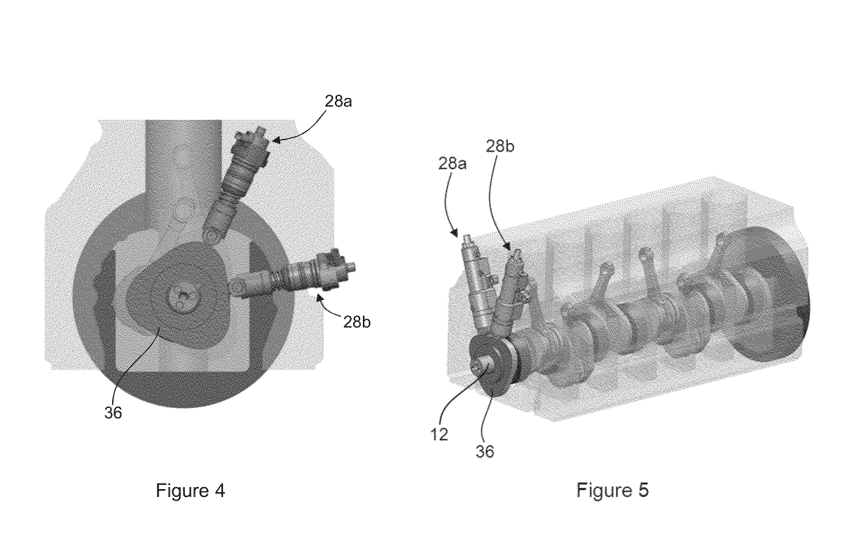

FIGS. 4 and 5 show an embodiment of the invention in which two unit pumps 28a, 28b are mounted on the same multi-lobe cam 36, angularly spaced around the crank shaft 12. Each unit pump may take the same form as described previously with reference to FIG. 2. The use of multiple unit pumps provides a pump assembly having a greater pump capacity as each of the unit pumps pressurises and delivers fuel to the downstream common rail three times per revolution of the crank shaft 12. It also provides the benefit of a more continuous pumping rate.

A multiple pump arrangement may be mounted within or to the engine block in a similar manner to as described previously for a single pump arrangement. Two (or more) unit pumps 28a, 28b may be housed within a common pump housing which may be received within a bore or pocket provided in the engine block 14. Alternatively, a common housing for two (or more) unit pumps 28a, 28b may be mounted within the engine block 14 or may form a bolt-on assembly to be bolted to the engine block 14 via a mounting arrangement, as described previously. If forming a bolt-on assembly, the unit pumps 28a, 28b may be housed within a common pump housing, or each may have its own dedicated pump housing which is mounted to the engine block via its own dedicated mounting plate and bolts.

In a hybrid unit pump/common rail type system, the unit pumps 28a, 28b may supply fuel to a common rail (not shown) of the fuel injection system which, in turn, supplies pressurised fuel to the fuel injectors in accordance with the selected injection strategy. In other arrangements, there may be no common rail and the unit pumps may supply pressurised fuel directly to a dedicated fuel injector (not shown).

In practice, in the arrangements in FIGS. 1 to 3, the same benefits will be realised if multiple unit pumps are mounted on a cam that is common to all unit pumps. In this case the cam may also be a multi-lobe can.

It will be appreciated that further modifications of the invention are envisaged without departing from the scope of the appended claims. For example, the cam may have any number of cam lobes and any number of a plurality of unit pumps may be mounted on the crank shaft 12. The fuel pump assembly need not be used in a common rail fuel system, but may be used in a fuel system in which each unit pump supplies pressurised fuel only to its dedicated injector.

1. A fuel pump assembly for an internal combustion engine comprising at least one engine cylinder into which fuel is injected, each cylinder having an associated cylinder piston which reciprocates within the associated cylinder in use, the fuel pump assembly comprising;
a plurality of unit pumps, each unit pump having a pumping plunger for pressurising fuel within an associated pump chamber for delivery of fuel to an associated fuel injector of the engine; and
a crank shaft which is driven rotationally by means of the or each cylinder piston, the crank shaft comprising a power output end, at which an engine gearbox is mounted, and an end remote from the power output end, the crank shaft carrying a cam which is arranged to drive the pumping plungers of the unit pumps and further carrying at least one crank assembly which is coupled to a respective one of the cylinder pistons, in use,
wherein the plurality of unit pumps are radially spaced around the crank shaft and located at the same axial position along the crank shaft so that each of the unit pumps is driven, in use, by the same cam.

2. A fuel pump assembly as claimed in claim 1, wherein the cam is mounted at the remote end of the crank shaft.

3. A fuel pump assembly as claimed in claim 1, wherein the cam is mounted on the crank shaft so that there is at least one crank assembly located between the cam and the remote end of the crank shaft.

4. A fuel pump assembly as claimed in claim 3, wherein the cam is mounted centrally on the crank shaft, approximately equidistant between the remote end and the power output end of the crank shaft.

5. A fuel pump assembly as claimed in claim 3, wherein the cam is mounted at or towards the power output end of the crank shaft.

6. A fuel pump assembly as claimed in claim 3, wherein the cam is mounted between a central point of the crank shaft and the power output end of the crank shaft.

7. A fuel pump assembly as claimed in claim 1, wherein the or each crank assembly includes a crank pin and a connecting rod which couples to the respective cylinder piston.

8. A fuel pump assembly as claimed in claim 1, further comprising an engine housing for the crank shaft, wherein each of the unit pumps is received at least partially within a bore provided within the engine housing.

9. A fuel pump assembly as claimed in claim 8, wherein the unit pumps are mounted fully within the engine housing.

10. A fuel pump assembly as claimed in claim 9, wherein a crank case for the crank shaft forms an integral part of the engine housing, and wherein the unit pumps are mounted fully within the crank case.

11. A fuel pump assembly as claimed in claim 1, further comprising mounting means for mounting the unit pumps externally to the engine housing.

12. A fuel pump as claimed in claim 11, wherein the unit pumps are mounted within a common pump housing which is mounted externally to the engine housing by means of the mounting means.

13. A fuel pump as claimed in claim 11, wherein each of the unit pumps is mounted within its own dedicated housing which is mounted to the engine housing by means of an associated mounting means.

14. A fuel pump assembly as claimed in claim 1, wherein each of the unit pumps further comprises a roller which cooperates with the cam and a shoe which at least partially encloses the roller and which is driven by the roller as it rides over the cam, in use, whereby the shoe cooperates with the associated pumping plunger so as to impart drive thereto as the cam rotates with the crank shaft.

15. A fuel pump assembly as claimed in claim 1, wherein each of the unit pumps further comprises a roller which cooperates with the cam and a follower which is driven by the roller as the roller rides over the cam, in use, whereby the follower cooperates with the pumping plunger so as to impart drive thereto as the cam rotates with the crank shaft.

16. A fuel pump assembly as claimed in claim 1, wherein the cam is a multi-lobe cam.

17. A fuel pump assembly as claimed in claim 1, further comprising a fly wheel mounted at the power output end of the crank shaft.

18. A fuel pump assembly as claimed in claim 1, wherein the cam forms an integral part of the crank shaft.

19. A fuel pump assembly as claimed in claim 1, wherein the cam is a separate component carried by the crank shaft.

20. A fuel pump assembly for an internal combustion engine comprising at least one engine cylinder into which fuel is injected, each cylinder having an associated cylinder piston which reciprocates within the associated cylinder in use, the fuel pump assembly comprising;
a unit pump having a pumping plunger for pressurising fuel within a pump chamber for delivery to one of more fuel injectors of the engine; and
a crank shaft which is driven rotationally by means of the or each cylinder piston, the crank shaft comprising a power output end, at which an engine gearbox is mounted, and an end remote from the power output end, and carrying a cam which is arranged to drive the pumping plunger of the unit pump and carrying at least one crank assembly, the or each crank assembly being coupled to a respective one of the cylinder pistons, in use;
wherein the cam is mounted on the crank shaft so that there is at least one crank assembly located between the cam and the remote end of the crank shaft.

21. A compression ignition internal combustion engine comprising a plurality of engine cylinders each having a reciprocal cylinder piston and a fuel pump assembly as claimed in claim 1, wherein the cylinder pistons drive rotation of the crank shaft, in use.
